(19) United States
(12) Patent Application Publication
(10) Pub. No.: US 2019/0179474 A1
(43) Pub. Date: Jun. 13, 2019

(54) CONTROL METHOD, ELECTRONIC DEVICE, AND NON-TRANSITORY COMPUTER READABLE RECORDING MEDIUM

(71) Applicant: ASUSTeK COMPUTER INC., TAIPEI (TW)

(72) Inventors: Meng-Ju LU, TAIPEI (TW); Chun-Tsai YEH, TAIPEI (TW); Hung-Yi LIN, TAIPEI (TW); Jung-Hsing WANG, TAIPEI (TW)

(21) Appl. No.: 16/211,529

(22) Filed: Dec. 6, 2018

(30) Foreign Application Priority Data
Dec. 13, 2017 (CN) 201711328329.0

(51) Int. Cl. G06F 3/041; G06F 3/0354

(52) U.S. Cl. CPC G06F 3/0416; G06F 3/03547

(57) ABSTRACT

An electronic device that includes a display screen, a touch screen, and a processor is disclosed. The touch screen is configured to provide a user interface area and a trackpad operation area and output touch information in response to a touch behavior. The processor is electronically connected to the display screen and the touch screen and configured to receive touch materials and determine whether the touch behavior relates to a user interface instruction or a trackpad operation instruction according to the touch information. When the processor determines that the touch behavior relates to the user interface instruction, the processor provides corresponding instruction code to an interactive service module according to the touch materials, so as to control an application program displayed on the display screen.

### CROSS-REFERENCE TO RELATED APPLICATION

This application claims the priority benefit of Chinese application serial No. 201711328329.0, filed on Dec. 13, 2017. The entirety of the above-mentioned patent application is hereby incorporated by reference herein and made a part of specification.

### BACKGROUND OF THE INVENTION

### Field of the Invention

The present invention relates to an electronic device, and more particularly, to a dual-screen electronic device.

### Description of the Related Art

Recently, Dual-screen is gradually and widely applied to various electronic products such as notebook computers to provide better user experience. A dual-screen electronic device often includes a main screen for output and another screen for touch operation.

### BRIEF SUMMARY OF THE INVENTION

According to a first aspect, an electronic device is provided herein. The electronic device includes a display screen, a touch screen, and a processor. The touch screen is configured to output touch information in response to a touch behavior. The processor is electronically connected to the display screen and the touch screen, and configured to receive the touch information and determine whether the touch behavior relates to a user interface instruction or a trackpad operation instruction according to the touch information. When the processor determines that the touch behavior relates to the user interface instruction, the processor controls an application program that displayed on the display screen is in controlled by the processor according to the touch information.

According to a second aspect of the disclosure, a control method applied to an electronic device is provided herein. The electronic device includes a display screen and a touch screen. The control method includes the steps of: receiving touch information output by the touch screen in response to a touch behavior; determining whether the touch behavior relates to a user interface instruction or a trackpad operation instruction according to the touch information; and controlling an application program displayed on the display screen according to the touch information when the touch behavior relates to the user interface instruction.

According to a third aspect of the disclosure, a non-transitory computer readable recording medium is provided herein., The non-transitory computer readable recording medium records at least one program instruction that applied to an electronic device. The electronic device includes a display screen and a touch screen. The electronic device that loaded with the program instruction performs the following steps of: receiving touch information output by the touch screen in response to a touch behavior; determining whether the touch behavior relates to a user interface instruction or a trackpad operation instruction according to the touch information; and controlling an application program displayed on the display screen according to the touch information when the touch behavior relates to the user interface instruction.

In view of the above, in the present disclosure, data transmission is performed through firmware and drivers based on a standard transmission protocol, thereby accelerating a data transmission speed. A communications transmission protocol can be an Inter-Integrated Circuit (I2C) transmission protocol in an embodiment, but the present disclosure is not limited thereby. Furthermore, in the present disclosure, different touch information is respectively provided to corresponding interactive service modules or drivers to perform a subsequent operation, thereby simplifying a touch information transmission flow and enhancing a transmission speed. Intercommunication between a display screen and a touch screen can be realized only through one operating system.

### BRIEF DESCRIPTION OF THE DRAWINGS

FIG. 1 is a schematic diagram showing an electronic device according to some embodiments of the present disclosure.

FIG. 2 is a schematic diagram showing a data transmission architecture according to some embodiments of the present disclosure.

FIG. 3 is a flowchart showing a control method of an electronic device according to some embodiments of the present disclosure.

FIG. 4 is a schematic diagram showing an electronic device according to other embodiments of the present disclosure.

FIG. 5 is a flowchart showing a control method of an electronic device according to other embodiments of the present disclosure.

### DETAILED DESCRIPTION OF THE EMBODIMENTS

The following describes the present disclosure in detail according to the embodiments and the accompanying drawings, so that the embodiments of the present disclosure can be more comprehensible. However, the embodiments provided herein are not intended to limit the scope of the present disclosure, and the description about structural operation is not intended to limit the performance sequence. Any structure formed by combining elements again and any device having equivalent effects all fall in the scope of the present disclosure. Furthermore, according to standards and common practices in industry, the drawings are only for auxiliary illustration and are not made according to original sizes. Actually, the sizes of various features can be enlarged or reduced randomly for convenient illustration. In the following illustration, same elements will be marked as same reference numbers, so as to be more comprehensible.

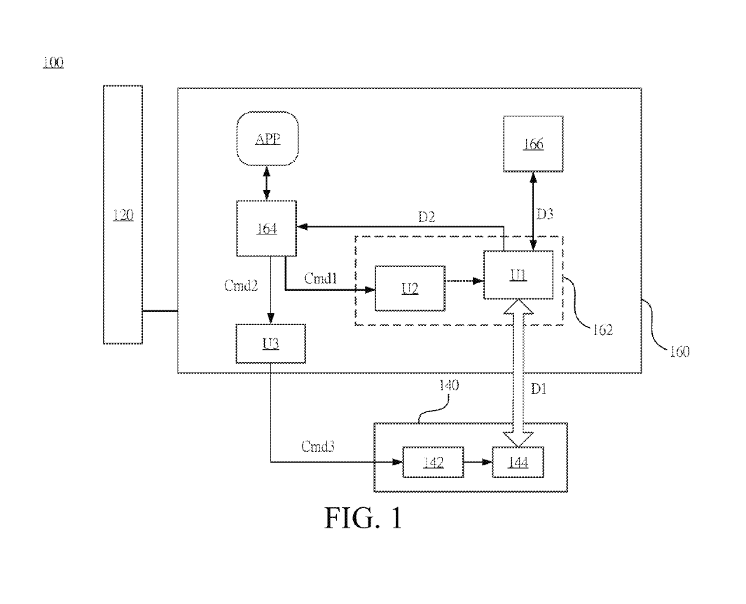

Referring to FIG. 1, FIG. 1 is a schematic diagram showing an electronic device 100 according to some embodiments of the present disclosure. In some embodiments, the electronic device 100 is a personal computer, a notebook computer, or a tablet computer having two screens. In an embodiment shown in FIG. 1, the electronic device 100 includes a display screen 120, a touch screen 140, and a processor 160. The display screen 120 is configured to provide an image output interface required when an application program is executed. The touch screen 140 is configured to enable a user to perform various touch input operations.

In an embodiment, the touch screen 140 provides one part of area as a user interface area to display a user interface for a user to perform an operation, and provides the other part of area as a trackpad operation area that is used to control a cursor on the display screen 120 or support a multi-touch gesture of user operation. In other words, the touch screen 140 is configured to provide a user interface area and a trackpad operation area, and output touch information D1 in response to a touch behavior of a user.

In specific, as shown in FIG. 1, in some embodiments, the touch screen 140 includes a touch information retrieval unit 142 and a bus controller unit 144 that are coupled to each other. When a user performs a touch behavior, the touch information retrieval unit 142 retrieves corresponding touch information D1. In an embodiment, the touch information D1 includes coordinate information or strength information of the touch point. When performing a subsequent operation, the processor 160 determines a position and strength of a user touch according to the touch information D1, so as to perform a corresponding operation.

When retrieving corresponding touch information D1, the touch information retrieval unit 142 outputs the touch information D1 to the processor 160 electronically connected with the touch screen 140 by a corresponding bus interface controlled by the bus controller unit 144. In some embodiments, the bus controller unit 144 includes a communications transmission controller unit (for example, an Inter-Integrated Circuit (I2C) controller unit), so as to transmit the touch information D1 through an I2C interface but is not limited thereby. In other embodiments, the touch screen 140 transmits the touch information D1 through various wired or wireless communications interfaces such as a Universal Serial Bus (USB), a Wireless Universal Serial Bus (WUSB) or Bluetooth.

Structurally, the processor 160 is electronically connected with the display screen 120 and the touch screen 140. The processor 160 receives touch information D1 from the touch screen 140, and determines whether the touch behavior of the user relates to a user interface instruction or a trackpad operation instruction according to the touch information D1. When the processor 160 determines the touch behavior of the user relates to the user interface instruction according to the touch information D1, an application program APP that displayed on the display screen is in controlled by the processor 160 according to the touch information D1. In some embodiments, the processor 160 includes a first driver module 162, an interactive service module 164, a second driver module 166, and a display instruction processing unit U3.

The processor 160 executes the first driver module 162 to receive the touch information D1 from the touch screen 140, and determines whether the touch behavior of the user relates to a user interface instruction or a trackpad operation instruction according to the touch information D1. When the first driver module 162 determines that the touch behavior relates to the user interface instruction, the first driver module 162 provides corresponding instruction code D2 to the interactive service module 164 according to the touch information D1. The processor 160 executes the interactive service module 164 to control an application program APP displayed on the display screen 120 and update an action interface displayed on the touch screen 140.

In specific, the instruction code D2 includes application program control information or a gesture instruction corresponding to the application program APP. The application program control information is used to control the corresponding application program APP to make the application program APP perform a corresponding operation, and the part of the gesture instruction will be described with reference to the accompanying drawings in subsequent embodiments.

In an embodiment, when the user clicks a button area marked as “Increase Brightness” on the touch screen 140, the first driver module 162 determines that the touch behavior relates to the user interface instruction according to coordinate information or strength information in the touch information D1, and provides instruction code D2 corresponding to “Increase Brightness” to the interactive service module 164. The interactive service module 164 controls to increase of brightness of a frame of the application program APP displayed on the display screen 120. In some embodiments, the instruction code D2 can be set according to the touch strength, so that when the user touches the button area with more strength, adjustment of brightness of the frame is accelerated.

In some embodiments, the display instruction processing unit U3 is electronically connected with the interactive service module 164 and touch information retrieval unit 142 of the touch screen 140, and is configured to convert an interface display instruction Cmd2 output by the interactive service module 164 into a display instruction Cmd3 that can be received by the touch screen 140, so as to control the touch screen 140 to display a user interface.

It should be noted that, the aforementioned operation is only exemplary, and is not used to limit the present disclosure. User interface instructions can be various different instructions, and designed according to requirements of different application programs APP. In an embodiment, when the application program APP is a video and audio playback program, the corresponding user interface instructions include relevant instructions about video and audio playback, such as fast forward or rewind. In another aspect, when the application program APP is a document processing program, the corresponding user interface instructions include document editing instructions of adjusting a font, a font size, and a color.

As shown in the figures, the first driver module 162 includes a touch behavior determining unit U1 and a user interface setting unit U2. The touch behavior determining unit U1 is coupled to the user interface setting unit U2, and is configured to determine whether the touch behavior relates to a user interface instruction or a trackpad operation instruction according to the touch information D1 and the user interface layout information in the user interface setting unit U2.

In an embodiment, the user interface setting unit U2 stores user interface layout information, the user interface layout information includes information such as the area in which part of the touch screen 140 serves as the user interface area, the area in which part serves as the trackpad operation area, and whose user interface instructions respectively corresponding to each coordinate range of the user interface area. In some embodiments, the setting of the user interface setting unit U2 can be dynamically adjusted according to operation states of different application programs APP.

As shown in FIG. 1, the interactive service module 164 outputs an interface setting instruction Cmd1 to the user interface setting unit U2. The user interface setting unit U2 records and transmits user interface layout information corresponding to the interface setting instruction Cmd1 to the touch behavior determining unit U1, so that the touch behavior determining unit U1 knows a current user interface layout.

Thus, the touch behavior determining unit U1 compares the coordinate information or strength information of the touch information D1 with user interface layout information received from the user interface setting unit U2, so as to determine a touch behavior. When the touch behavior determining unit U1 determines that the touch behavior relates to a user interface instruction, the first driver module 162 provides corresponding instruction code D2 to the interactive service module 164 by the touch behavior determining unit U1. The processor 160 performs the interactive service module 164, so as to perform relevant operations on the application program APP.

In another aspect, when the touch behavior determining unit U1 determines that the touch behavior relates to a trackpad operation instruction, the first driver module 162 provides trackpad operation data D3 corresponding to the touch information D1 to the second driver module 166 by the touch behavior determining unit U1. The processor 160 performs the second driver module 166 to perform relevant system operation and control. In an embodiment, the second driver module 166 includes an inbox driver of an operating system, for example, a Windows precision touchpad driver.

According to the aforementioned operations, the first driver module 162 selectively outputs instruction code D2 to the interactive service module 164 or outputs trackpad operation data D3 to the second driver module 166 according to different touch information D1.

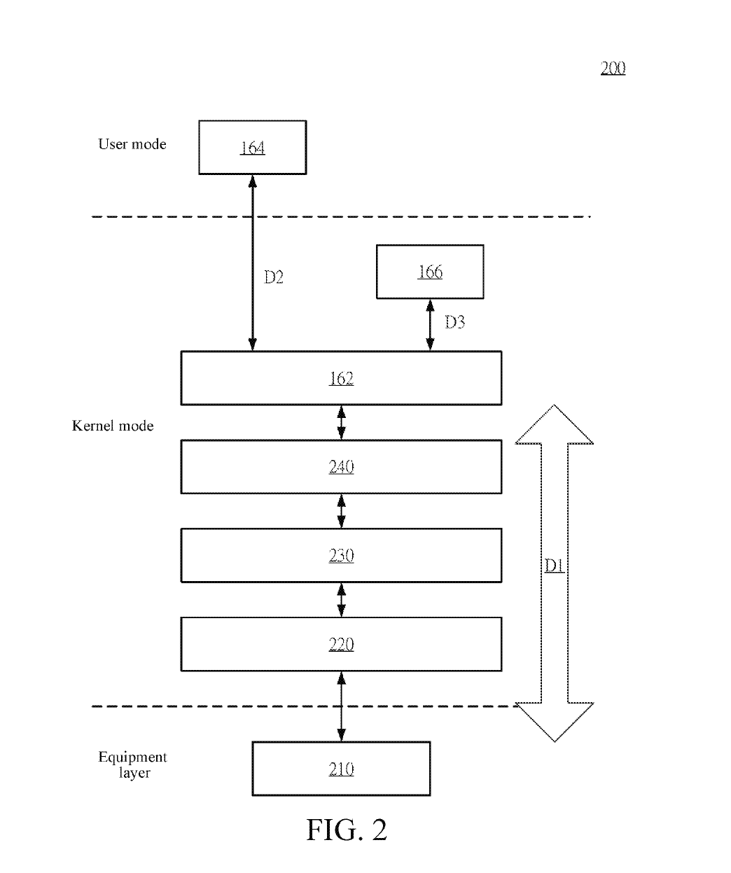

Referring to FIG. 2, FIG. 2 is a schematic diagram showing a data transmission architecture 200 according to some embodiments of the present disclosure. Elements in FIG. 2 that are similar to those in the embodiment in FIG. 1 are marked with same reference numbers, so as to be more comprehensible, the specific principle of the similar elements has been described in detail in preceding paragraphs, and elements will not be introduced if they have no cooperative operation relationship with the elements in FIG. 2.

As described in the preceding paragraphs, in some embodiments, the touch screen 140 and the processor 160 perform two-way data communication via a communications transmission interface 210, but the present disclosure is not limited thereby. In the embodiment shown in FIG. 2, a communications transmission interface 210 (for example, an I2C bus) on a n equipment layer can communicate with a communications transmission controller 220 (for example, an I2C controller) on an upper layer on an kernel mode. In some embodiments, the communications transmission controller 220 can include a communications transmission controller driver of a third party. The communications transmission controller 220 can communicate with a human interface device (HID) driver 230 (for example, HIDI2C.Sys driver) built in a layer of upper than the layer that the communications transmission controller 220 built in. The HID driver 230 communicates with an HID class driver 240 (for example, HIDClass.Sys driver) built in a layer upper than the layer that the HID driver 230 built in. And, the HID class driver 240 communicates with the first driver module 162 built in a layer upper than the layer that the HID class driver 240, so that the first driver module 162 acquires the touch information D1.

The first driver module 162 executed in a kernel mode can further communicate with the interactive service module 164 executed in a user mode and the second driver module 166 executed in the kernel mode, so as to provide the instruction code D2 to the interactive service module 164, or provide the trackpad operation data D3 to the second driver module 166.

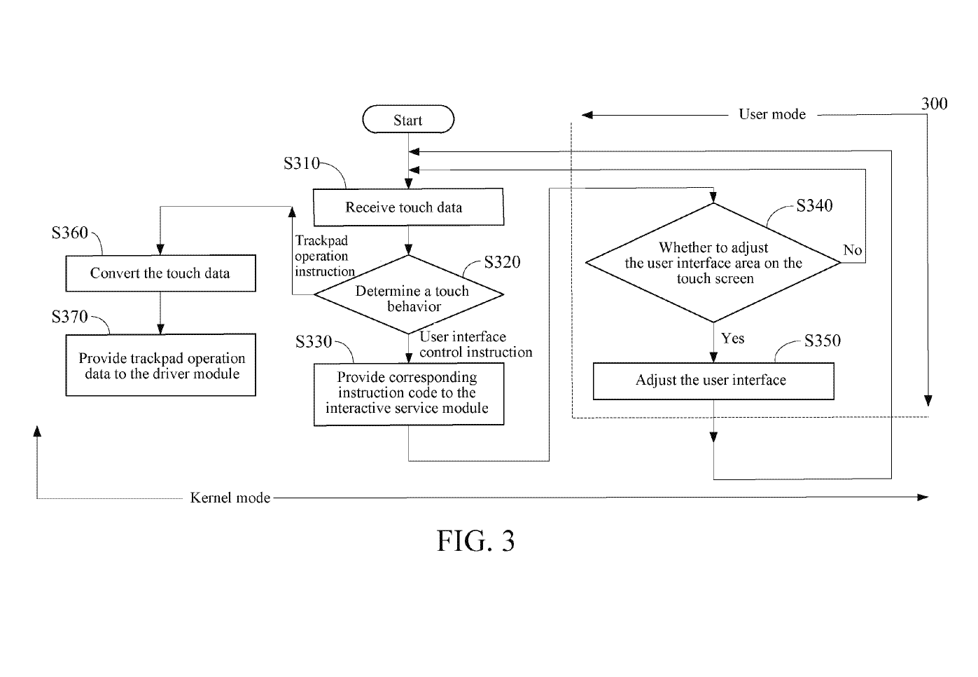

Referring to FIG. 3, FIG. 3 is a flowchart showing a control method 300 of an electronic device 100 according to some embodiments of the present disclosure. To describe conveniently and clearly, the control method 300 is described with reference to the embodiment in FIG. 1, but the present disclosure is not limited thereby. A person skilled in the art can make various changes and modifications without departing from the spirit and scope of the present disclosure. As shown in FIG. 3, the control method 300 includes steps S310, S320, S330, S340, S350, S360, and S370.

First, in step S310, the processor 160 receives touch information D1 output by the touch screen 140 in response to a touch behavior.

Then, in step S320, the processor 160 determines whether the touch behavior relates to a user interface instruction or a trackpad operation instruction according to the touch information D1. In specific, the electronic device 100 determines whether the touch behavior relates to a user interface instruction or a trackpad operation instruction according to the touch information D1 and the setting of the user interface setting unit U2 by the touch behavior determining unit U1 of the processor 160.

When the touch behavior relates to the user interface instruction is determined, step S330 is then performed. In step S330, the processor 160 provides corresponding instruction code D2 to the interactive service module 164 according to the touch information D1, so as to control an application program APP displayed on the display screen 120 or update a corresponding user interface on the touch screen 140.

Then, in step S340, the interactive service module 164 determines whether it is necessary to adjust a user interface. If it is not necessary to adjust a user interface, step S310 is performed again to receive new touch information D1.

If the interactive service module 164 determines that it is necessary to adjust the user interface, step S350 is performed. In step S350, the interactive service module 164 outputs interface adjustment setting data to adjust the user interface. In an embodiment, the interface adjustment setting data includes an interface display instruction Cmd2 and an interface setting instruction Cmd1.

In specific, the interactive service module 164 outputs the interface display instruction Cmd2 to the display instruction processing unit U3. In an embodiment, the display instruction processing unit U3 can be a Graphics Processing Unit, (GPU). The interactive service module 164 uses the display instruction processing unit U3 to convert the interface display instruction Cmd2 into a display instruction Cmd3 that can be received by the touch screen 140, so as to control the touch screen 140 to display the user interface. Furthermore, the interactive service module 164 additionally outputs an interface setting instruction Cmd1 to the user interface setting unit U2, and the interface setting instruction Cmd1 includes user interface layout information. In an embodiment, the user interface setting unit U2 records the user interface layout information and transmits the user interface layout information to the touch behavior determining unit U1, so that the touch behavior determining unit U1 knows the current user interface layout.

Next, the electronic device 100 returns to step S310 to receive new touch information D1 again.

The touch behavior determining unit U1 of the first driver module 162 determines a subsequent touch behavior according to the touch information D1 and setting of a new user interface setting unit U2 (for example, the user interface layout information).

In an embodiment, in step S330, the requirement corresponding to the instruction code D2 received by the interactive service module 164 is to modify a font color, and then, the interactive service module 164 outputs interface adjustment setting information based on instruction code D2, so as to update the user interface as a layout of a coloring plate, for example, each coordinate range in the user interface area displays a different color. Thus, a user can select a desired font color by touching different areas of the touch screen 140.

In another aspect, when the touch behavior relates to the trackpad operation instruction, the electronic device 100 performs steps S360 and S370.

In step S360, the electronic device 100 converts touch information D1 by using the data processing unit U4 in the processor 160. In some embodiments, the processor 160 further includes a corresponding data processing unit U4 that configured to process touch information D1 to acquire trackpad operation data D3. Then, in step S370, the touch behavior determining unit U1 provides trackpad operation data D3 corresponding to the touch information D1 to the second driver module 166. Thus, the second driver module 166 operates and controls the system correspondingly according to the trackpad operation data D3.

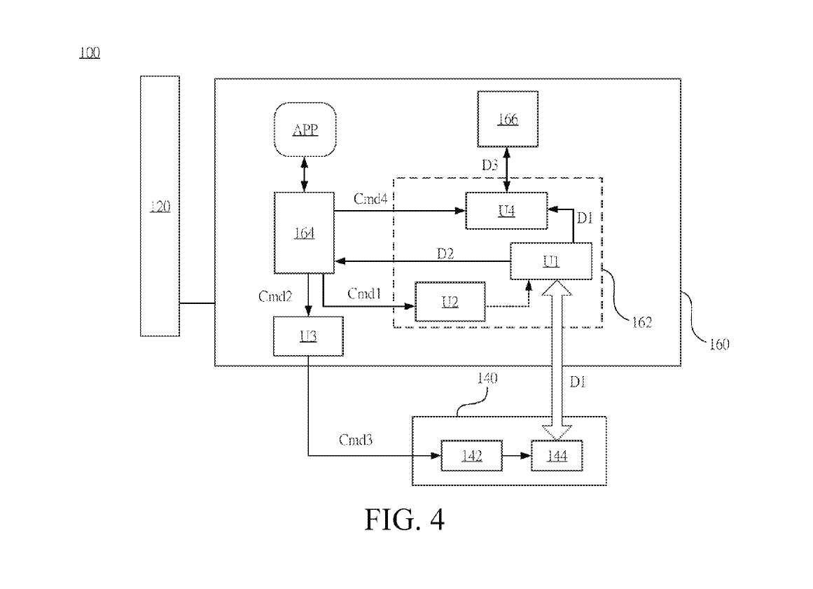

Referring to FIG. 4, FIG. 4 is a schematic diagram showing an electronic device 100 according to other embodiments of the present disclosure. Elements in FIG. 4 that are similar to those in the embodiment in FIG. 1 are marked with same reference numbers so as to be more comprehensible, the specific principle of the similar elements has been described in preceding paragraphs, and the elements will not be introduced if they have no cooperative operation relationship with the elements in FIG. 4.

Compared with the electronic device 100 in FIG. 1, in the embodiment shown in FIG. 4, the first driver module 162 further includes a data processing unit U4. Furthermore, in some embodiments, the electronic device 100 in FIG. 1 also includes a data processing unit U4.

The data processing unit U4 is coupled to the touch behavior determining unit U1, so as to process touch information D1 output by the touch behavior determining unit U1 to provide trackpad operation data D3 to the second driver module 166. In specific, since the data format required by the first driver module 162 and interactive service module 164 is possibly different from the data format that can be accessed by the second driver module 166, the data processing unit U4 can be used to convert a data format, so that each of the driver modules 162 and 166 and the interactive service module 164 can communicate with each other.

In some embodiments, the data processing unit U4 is further coupled to the interactive service module 164 to receive a gesture instruction Cmd4 from the interactive service module 164, and provide the trackpad operation data D3 to the second driver module 166 according to the gesture instruction Cmd4 after receiving the gesture instruction Cmd4.

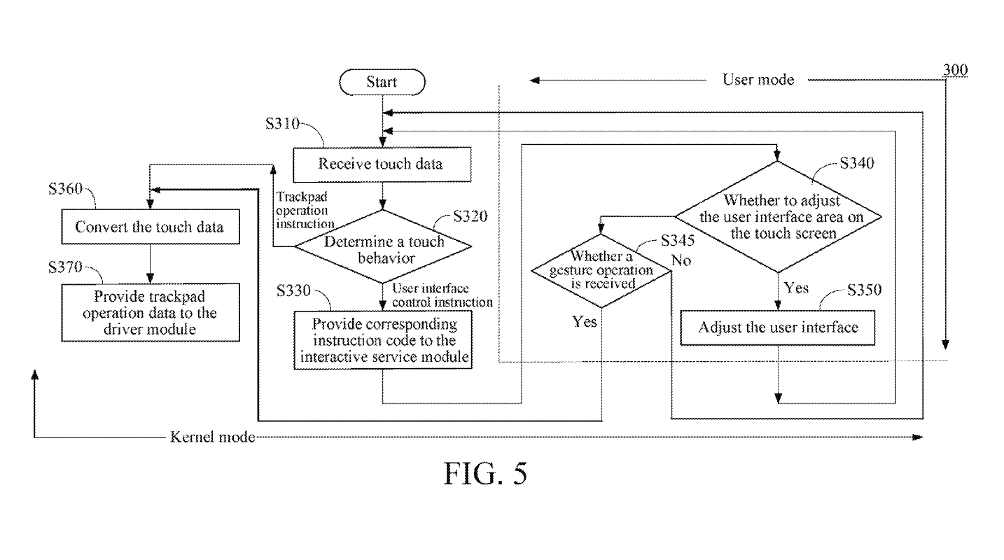

To describe more conveniently, in the following paragraphs, the detailed operation of the data processing unit U4 in FIG. 4 will be described with reference to the flowchart. Referring to FIG. 5, FIG. 5 is a flowchart showing a control method 300 of an electronic device 100 according to other embodiments of the present disclosure. To describe clearly and conveniently, the control method 300 is described with reference to the embodiment in FIG. 4, but the present disclosure is not limited thereby.

Compared with the control method 300 shown in FIG. 3, in this embodiment, the method further includes step S345. If, in step 340, the processor 160 determines it is not necessary to adjust the user interface data on the touch screen 140, step S345 is performed.

In step S345, the interactive service module 164 determines whether a gesture operation is received. If the gesture operation is not received, step S310 is performed again to receive new touch information D1.

If the gesture operation is received, the interactive service module 164 transmits the gesture instruction Cmd4 to the data processing unit U4 in the processor 160 to perform steps S360 and S370. In steps S360 and S370, the data processing unit U4 provides trackpad operation data D3 to the second driver module 166.

In specific, in step S360, the data processing unit U4 in the processor 160 converts the touch information, and converts the gesture instruction Cmd4 into a suitable format as the trackpad operation data D3. Then, in step S370, the data processing unit U4 outputs and provides the corresponding trackpad operation data D3 to the second driver module 166. Thus, the second driver module 166 operates and controls a system correspondingly according to the trackpad operation data D3.

In an embodiment, when an application program APP is executed, to make a user zoom an object by the gesture of two fingers, the interactive service module 164 can output the gesture instruction Cmd4 to the data processing unit U4, the data processing unit U4 processes the gesture instruction Cmd4 to output trackpad operation data D3 to the second driver module 166. The application program APP determines a gesture operation of the user via the second driver module 166, and performs computation processing according to the setting of the application program APP.

It should be noted that, the examples are only for convenient description and are not intended to limit the present disclosure. If the application program APP intends to call the second driver module 166 to perform other relevant operation, the interactive service module 164 can also be used to output a corresponding instruction to the data processing unit U4, so that the data processing unit U4 converts relevant data into a suitable format and provides the same to the second driver module 166 to perform computation, so as to realize cooperation between each of the driver modules.

In other words, in step S360, the data processing unit U4 can process the touch information D1 to acquire trackpad operation data D3, and can also process various instructions, such as a gesture instruction Cmd4, output by the interactive service module 164, so as to acquire the trackpad operation data D3.

In view of the above, in each embodiment of the present disclosure, data transmission is performed through firmware and drivers based on a standard transmission protocol, for example, an I2C transmission protocol, thereby accelerating a data transmission speed. Furthermore, the first driver module 162 provides different touch information to corresponding interactive service modules 164 and 166 respectively to perform a subsequent operation, thereby simplifying a transmission process of touch information and enhancing a transmission speed. Intercommunication between a display screen 120 and a touch screen 140 can be realized only through one operating system.

It should be noted that, in a situation of no conflicts, each drawing, each embodiment, and the features and circuits in the embodiments in the present disclosure can be combined with each other. The circuits in the drawings are only exemplary, are simplified to make the description simple and comprehensible, and are not intended to limit the present disclosure.

Although the embodiments of the present disclosure have been disclosed above, the embodiments are not intended to limit the present disclosure. A person skilled in the art can make some changes and modifications without departing from the spirit and scope of the present disclosure. The protection scope of the present disclosure should depend on the claims.

What is claimed is:

1. An electronic device, comprising:
a display screen;
a touch screen, configured to output touch information in response to a touch behavior; and
a processor, electronically connected to the display screen and the touch screen, and configured to receive the touch information and determine whether the touch information relates to a user interface instruction or a trackpad operation instruction according to the touch information;
wherein when the processor determines that the touch behavior relates to the user interface instruction, an application program that displayed on the display screen is in controlled by the processor according to the touch information.

2. The electronic device according to claim 1, wherein the processor comprises a first driver module, and the first driver module comprises:
a user interface setting unit, configured to output user interface layout information; and
a touch behavior determining unit, coupled to the user interface setting unit, and configured to determine whether the touch behavior belongs to the user interface instruction or the trackpad operation instruction according to the touch information and the user interface layout information.

3. The electronic device according to claim 2, wherein when the touch behavior determining unit determines that the touch behavior relates to the trackpad operation instruction, the touch behavior determining unit provides trackpad operation data corresponding to the touch information to a second driver module in the processor; and
when the touch behavior determining unit determines that the touch behavior relates to the user interface instruction, the touch behavior determining unit provides instruction code corresponding to the touch information to an interactive service module of the processor.

4. The electronic device according to claim 3, wherein the first driver module further comprises:
a data processing unit, coupled to the touch behavior determining unit, and configured to process the touch information to provide the trackpad operation data to the second driver module.

5. The electronic device according to claim 4, wherein the data processing unit is further configured to receive a gesture instruction from the interactive service module, and provide the trackpad operation data to the second driver module according to the gesture instruction.

6. A control method, applied to an electronic device, wherein the electronic device comprises a display screen and a touch screen, and the control method comprises:
receiving touch information output by the touch screen in response to a touch behavior;
determining whether the touch behavior relates to a user interface instruction or a trackpad operation instruction according to the touch information; and
controlling an application program displayed on the display screen according to the touch information when the touch behavior relates to the user interface instruction.

7. The control method according to claim 6, wherein the step of determining whether the touch behavior relates to the user interface instruction or the trackpad operation instruction according to the touch information further comprises:
providing, by a touch behavior determining unit of a processor, trackpad operation data corresponding to the touch information to a second driver module of the processor when the touch behavior determining unit of the processor determines that the touch behavior relates to the trackpad operation instruction; and
providing, by the touch behavior determining unit, instruction code corresponding to the touch information to an interactive service module of the processor when the touch behavior determining unit determines that the touch behavior relates to the user interface instruction.

8. The control method according to claim 7, wherein after the step of providing, by the touch behavior determining unit, the corresponding instruction code to the interactive service module of the processor, the control method further comprises:
determining, by the interactive service module, whether to adjust at least one user interface area on the touch screen; and
outputting, by the interactive service module, interface adjustment setting data to adjust the user interface area on the touch screen when the interactive service module determines to adjust the at least one user interface area on the touch screen.

9. The control method according to claim 7, wherein after the step of providing, by the touch behavior determining unit, the corresponding instruction code to the interactive service module of the processor, the control method further comprises:
determining, by the interactive service module, whether a gesture operation is received;
transmitting, by the interactive service module, a gesture instruction to a data processing unit of the processor when the interactive service module determines the gesture operation is received; and
providing, by the data processing unit, the trackpad operation data to the second driver module according to the gesture instruction.

10. A non-transitory computer readable recording medium, wherein the non-transitory computer readable recording medium records at least one program instruction, the program instruction is applied to an electronic device, the electronic device comprises a display screen and a touch screen, and when the program instruction is loaded to the electronic device, the electronic device performs following steps:
receiving touch information output by the touch screen in response to a touch behavior;
determining whether the touch behavior relates to a user interface instruction or a trackpad operation instruction according to the touch information; and
controlling an application program displayed on the display screen according to the touch information when the touch behavior relates to the user interface instruction.
